(19) United States
(12) Patent Application Publication
(10) Pub. No.: US 2021/0378913 A1
(43) Pub. Date: Dec. 9, 2021

(54) ACUPUNCTURE NEEDLE

(71) Applicant: SEIRIN CORPORATION, Shizuoka-shi (JP)

(72) Inventors: Ryoichi NAKANO, Shizuoka (JP); Yuya KANEKO, Shizuoka (JP); Shohei TANIGUCHI, Shizuoka (JP); Takuya KOBAYASHI, Shizuoka (JP)

(21) Appl. No.: 17/126,027

(22) Filed: Dec. 18, 2020

(30) Foreign Application Priority Data
Jun. 3, 2020 (JP) 2020-096730

(51) Int. Cl. A61H 39/08

(52) U.S. Cl. CPC A61H 39/086; A61H 39/083

(57) ABSTRACT

An acupuncture needle is an acupuncture needle including a needle body having a needle tip portion at a leading end thereof, and a needle grip attached to a base end portion of the needle body. A cross-sectional shape crossing a longitudinal direction of the needle grip is an ellipse.

### RELATED APPLICATION

The present application claims priority to Japanese Application Number 2020-096730 filed Jun. 3, 2020, the disclosure of which is hereby incorporated by reference herein in its entirety.

### TECHNICAL FIELD

The instant application relates to an acupuncture needle, and in particular to an acupuncture needle having good usability.

### BACKGROUND TECHNOLOGY

There are acupuncture needles having a needle body having a needle tip portion formed at a leading end thereof and a needle grip attached to a base end portion of the needle body (Patent Literature 1).

Commonly, a cross-sectional shape crossing a longitudinal direction of the needle grip is a true circle.

### PRIOR ART REFERENCES

### Patent Literature

[Patent Literature 1] Japanese Patent Publication No. 2019-136385

### SUMMARY

### Problems to be Solved

However, for example, in a case in which the acupuncture needle is inserted into a side surface of the face, the acupuncture needle may bend, and come out. On the other hand, there was also a problem for the patient wherein the acupuncture needle may wobble after insertion causing discomfort and pain to the patient.

In order to reduce the amount of bending of the acupuncture needle, the cross-sectional shape crossing the longitudinal direction of the needle grip being the true circle may be made smaller; however, if made too small, the acupuncture needle becomes difficult to pick up by hand and hinder the treatment.

The present application provides an acupuncture needle in consideration of the above-mentioned problems.

### BRIEF DESCRIPTION OF THE DRAWINGS

FIG. 1 is a schematic front view of an acupuncture needle according to at least one embodiment of the present application.

FIG. 2A is a cross-sectional view taken along the line 2-2 of FIG. 1, FIG. 2B is a cross-sectional view taken along the line 2′-2′ of FIG. 1, and FIG. 2C is a schematic cross-sectional view of a needle grip of a conventional acupuncture needle.

FIG. 3 is a schematic cross-sectional view of the needle grip in FIG. 2A held by an index finger and a thumb.

FIG. 4 is a schematic cross-sectional view of the needle grip in FIG. 2A being placed on a mounting surface.

FIG. 5 is a schematic perspective view of a plurality of acupuncture needles in FIG. 1 being applied to a face.

FIG. 6 is a schematic plan view of a plurality of acupuncture needles in FIG. 1 being applied to the face.

FIG. 7 is a schematic front view of an acupuncture needle of at least one embodiment different from that in FIG. 1.

FIG. 8A is a cross-sectional view taken along the line 8-8 in FIG. 7, FIG. 8B is a cross-sectional view taken along the line 8′-8′ in FIG. 7, and FIG. 8C is a schematic cross-sectional view of a needle grip with corners in FIG. 8A being chamfered.

FIG. 9 is a schematic front view of an acupuncture needle of at least one embodiment different from that in FIG. 7.

FIG. 10A is a cross-sectional view taken along the line 10-10 in FIG. 9, FIG. 10B is a cross-sectional view taken along the line 10′-10′ in FIG. 9, and FIG. 10C is a schematic cross-sectional view of a needle grip with corners in FIG. 10A being chamfered.

FIG. 11A is a schematic perspective view of the needle body of the acupuncture needle in FIG. 1 being inserted into a needle tube, and FIG. 11B is a schematic perspective view of the needle grip in FIG. 11A being inserted into the needle tube.

FIG. 12 is a schematic cross-sectional view of the needle grip in FIG. 2A being inserted into the needle tube.

FIG. 13 is a schematic cross-sectional view of the needle grip in FIG. 8C being inserted into the needle tube.

FIG. 14 is a schematic cross-sectional view of the needle grip in FIG. 10C being inserted into the needle tube.

### DETAILED DESCRIPTION

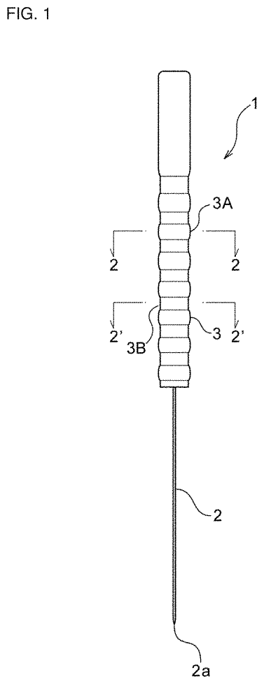

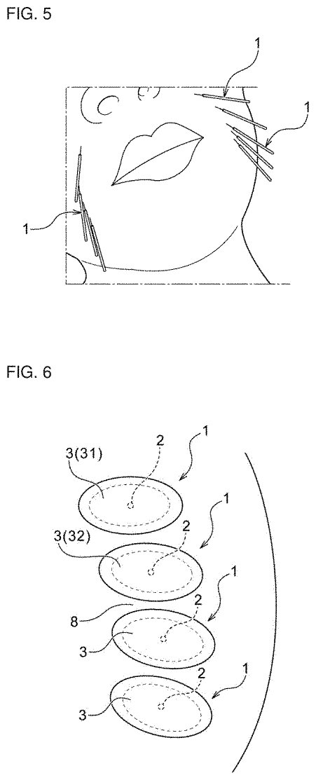

An acupuncture needle according to at least one embodiment of the present application will be described with reference to FIGS. 1-6. Reference 1 shown in FIG. 1 refers to an acupuncture needle, and the acupuncture needle 1 includes a needle body 2 having a needle tip portion formed at a leading end thereof and a needle grip 3 attached to a base end portion of the needle body 2. The needle tip portion of the acupuncture needle 1 has a pointed-shaped rather than a hook-shaped, the needle body 2 is in a linear shape without being curved in the middle, and the needle body 2 is not removable from the needle grip 3.

The needle body 2 is a linear body made of metal such as stainless steel, and the needle tip portion 2a is formed at the leading end thereof. The needle body 2 has a thickness and a length suitable for therapeutic purposes, manual procedures, and the like. A thickness (wall thickness) of the needle body 2 is, for example, 0.10 mm to 0.35 mm, and the length is, for example, 3 mm to 150 mm.

The needle grip 3 is made of plastic or metal such as stainless steel, attached to the base end portion of the needle body 2, and serves as a grip portion for holding the acupuncture needle 1. The cross-sectional shape crossing the longitudinal direction of the needle grip 3 is an ellipse. The cross-sectional shape of the needle grip 3 crossing the longitudinal direction is an ellipse for the following reasons.

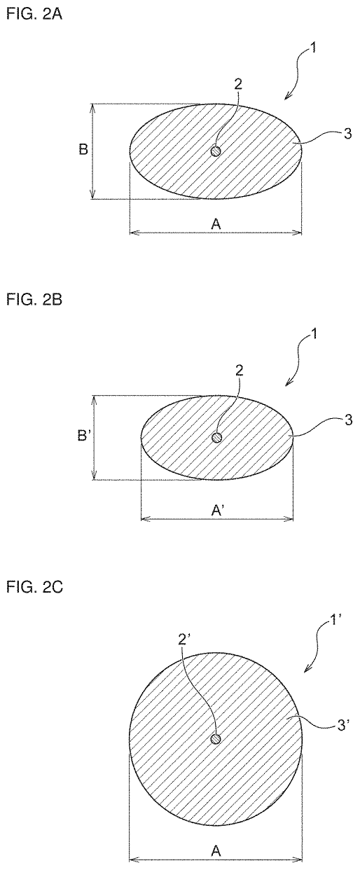

That is, as shown in FIGS. 2A and 2C, comparing the cross-sectional shape crossing the longitudinal direction of the needle grip 3 being the ellipse wherein the major axis is a dimension A to the cross-sectional shape crossing the longitudinal direction of the needle grip 3 being a true circle wherein the diameter is a dimension A, the cross-sectional shape crossing the longitudinal direction of the needle grip 3 being the ellipse has a smaller cross-sectional area than that of the needle grip 3 being the true circle so that the weight of the needle grip 3 can be reduced for weight saving. For example, in a case in which the acupuncture needle 1 is inserted into the side surface of the face, the acupuncture needle 1 is less likely to bend and the acupuncture needle 1 is prevented from falling out. In addition, even for the patient, the acupuncture needle 1 is less likely to wobble after the insertion and the discomfort of the patient is reduced.

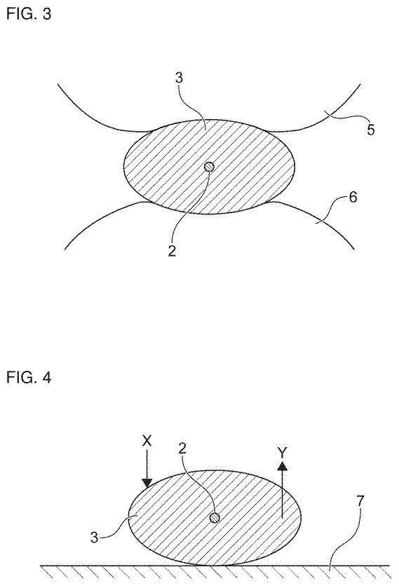

Moreover, by the cross-sectional shape being the ellipse, that is, by the difference (major axis A dimension−minor axis B dimension), the acupuncture needle 1 can be brought closer to apply a plurality of acupuncture needles 1, and the cross-sectional shape being the ellipse, the ease of holding the needle grip 3 can be maintained (as shown in FIG. 3, the needle grip 3 can be gripped by the index finger 5 and the thumb 6 even if the cross-sectional shape of the needle grip 3 in the longitudinal direction becomes small).

In addition, by the cross-sectional shape being the ellipse, a rotating operation of the needle grip 3 is made difficult after the practitioner inserts the acupuncture needle 1, and a unique effect is achieved wherein a damage to the needle body 2 having a low (small) rigidity due to the rotation of the needle grip 3 can be prevented.

Further, for example, as shown in FIG. 4, even if the acupuncture needle 1 is placed on the flat mounting surface 7, because the cross-sectional shape is the ellipse, when one end of the needle grip 3 placed on the mounting surface 7 is pushed in X direction, the other end of the needle grip 3 is separated from the mounting surface 7 in Y direction, so that the needle grip 3 can be easily grasped.

In addition, because the minor axis of the ellipse is along the lateral direction of the needle grip 3, the dimension of the needle grip 3 in the lateral direction can be shortened and made compact.

Further, FIG. 6 is a schematic plan view showing a state in which a plurality of acupuncture needles 1 is inserted into the skin 8 and the plurality of acupuncture needles 1 is arranged side by side. From the plan view, one of the needle grip 3 (31) of the needle body 2 arranged side by side and the other of the needle grip 3 (32) of the needle body 2 are separated from each other, and a first long side, to be described later, of one of the needle grip 3 (31) of the needle body 2 arranged side by side (in a case in which the cross-sectional shape is an ellipse, the first long side is the major axis of the ellipse) and a first long side, to be described later, of the other of the needle grip 3 (32) of the needle body 2 arranged side by side (in a case in which the cross-sectional shape is an ellipse, the first long side is the major axis of the ellipse.) are placed substantially parallel to each other.

In a method of placing the plurality of acupuncture needles side by side wherein the acupuncture needle 1 including a needle body 2 having a needle tip portion formed at a leading end thereof and a needle grip 3 attached to a base end portion of the needle body 2 is inserted into the skin, the cross-sectional shape crossing the longitudinal direction of the needle grip 3 shown in FIG. 6 is not limited to an ellipse, and the cross-sectional shape crossing the longitudinal direction of the needle grip 3 being a rectangle, rhombus, or the like wherein “among straight lines crossing an outer peripheral edge of the cross section crossing the longitudinal direction of the needle grip 3, a first long side having the length longest between one portion of the outer peripheral edge and another portion of the outer peripheral edge, and among the straight lines orthogonal to this first long side and crossing the outer peripheral edge of the cross section, a second long side having the length longest between one portion of the outer peripheral edge and another portion of the outer peripheral edge, a relation satisfies the length of the first long side>the length of the second long side” is applicable.

Further, as shown in FIG. 1, an outer surface of the needle grip 3 has a convex-concave shape along the longitudinal direction of the needle grip 3, and a cross-sectional shape crossing the longitudinal direction of the needle grip 3 at a convex-shape portion 3A is an ellipse [see FIG. 2A], and a cross-sectional shape crossing the longitudinal direction of the needle grip 3 at a concave-shape portion 3B is an ellipse [FIGS. 2A and 2B, A>A′ and B>B′]. That is, because the contact surface area with the needle grip 3 and the finger becomes large, the needle grip 3 is easier for the practitioner to hold and the usability can be improved.

According to this method of placing the plurality of acupuncture needles, from the plan view, one of the needle grip 3 (31) of the needle body 2 arranged side by side and the other of the needle grip 3 (32) of the needle body 2 arranged side by side are separated from each other, and a major axis of the ellipse of the one of needle grip 3 (31) of the needle body 2 arranged side by side and a major axis of the ellipse of the other of needle grip 3 (32) of the needle body 2 arranged side by side are placed substantially parallel to each other so that arranging a large number of acupuncture needles 1 in close proximity to each other and perform the treatment is possible.

In at least the above-described embodiment, the needle grip 3 of the acupuncture needle 1 of the present application, although not shown, can have the cross-sectional shape crossing the longitudinal direction of the needle grip 3 be an ellipse without a convex-concave portion along the longitudinal direction of the needle grip 3. However, in at least one embodiment, as shown in FIGS. 1, 2A, and 2B, a convex-concave portion may be formed on the surface of the needle grip 3 along the longitudinal direction of the needle grip 3 with the cross-sectional shape crossing the longitudinal direction being an ellipse.

The present application is not limited to the ellipse, and a rectangle, rhombus, or the like is applicable beside the ellipse, in a case wherein among straight lines crossing an outer peripheral edge of a cross section crossing the longitudinal direction of the needle grip 3 at the convex portion of the needle grip 3, a first long side A (length A) having the length longest between one portion of the outer peripheral edge and another portion of the outer peripheral edge and among the straight lines orthogonal to this first long side A (length A) and crossing the outer peripheral edge of the cross section, a second long side B (length B) having the length longest between one portion of the outer peripheral edge and another portion of the outer peripheral edge are in a relation satisfying the length A of the first long side>the length B of the second long side; and among the straight lines crossing the outer peripheral edge of the cross section crossing the longitudinal direction of the needle grip 3 at the concave portion of the needle grip 3, a first′ long side A′ (length A′) having the length longest between one portion of the outer peripheral edge and another portion of the outer peripheral edge and among the straight lines orthogonal to this first′ long side A′ (length A′) and crossing the outer peripheral edge of the cross section, a second′ long side B′ (length B′) having the length longest between one portion of the outer peripheral edge and another portion of the outer peripheral edge are in a relation satisfying the length A′ of the first′ long side>the length B′ of the second′ long side.

That is, the cross-sectional shape crossing the longitudinal direction of the needle grip 3 may be a polygon or a polygon with chamfered corners.

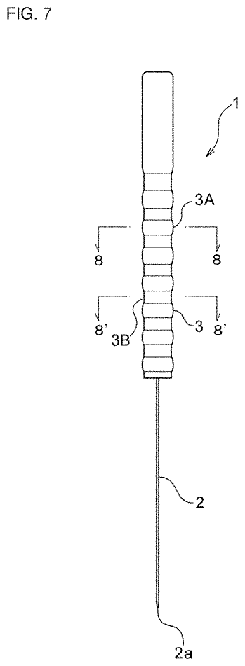

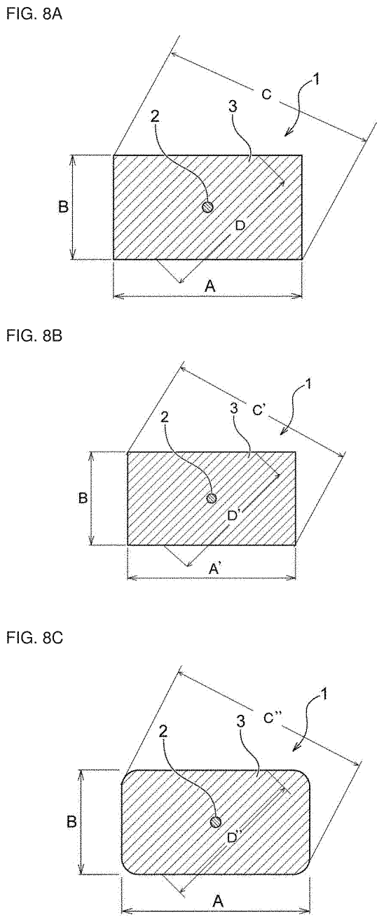

For example, in a case of the rectangle shown in FIGS. 7, 8A, and 8B, the length of the first long side is C, the length of the second long side is D (C>D), the length of the first′ long side is C′, and the length of the second′ long side is D′ (C′>D′). Among C, D, C′, and D′, the length C of the first long side is the longest. Similarly, in a case of the rectangle with chamfered corners shown in FIG. 8C, the length C″ of the first long side is the longest.

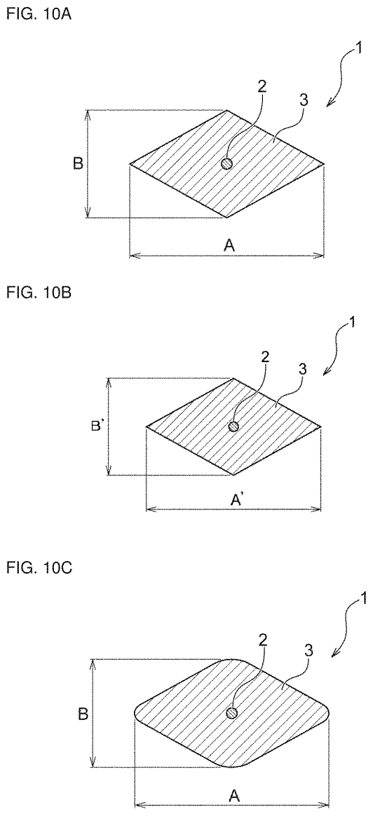

In addition, in a case of a rhombus shown in FIGS. 10A and 10B, among diagonal lines, the length of the first long side, which is the longer diagonal line, is A, the length of the second long side, which is the shorter diagonal line, is B (A>B), the length of the first′ long side is A′, and the length of the second′ long side is B′ (A′>B′). Among A, B, A′, and B′, the length A of the first long side is the longest. Similarly, in the case of the rhombus with chamfered corners shown in FIG. 10C, the length A of the first long side is the longest.

Even if the cross-sectional shape of the needle grip 3 crossing the longitudinal direction is a polygon or a polygon with chamfered corners (e.g., a rectangle, a rectangle with chamfered corners, a rhombus, or a rhombus with chamfered corners), has the same effect as the cross-sectional shape crossing the longitudinal direction of the needle grip 3 being an ellipse.

In the case in which the cross-sectional shape crossing the longitudinal direction of the needle grip 3 is the ellipse, the first long side described above is the major axis of the ellipse, and the second long side described above is the minor axis of the ellipse.

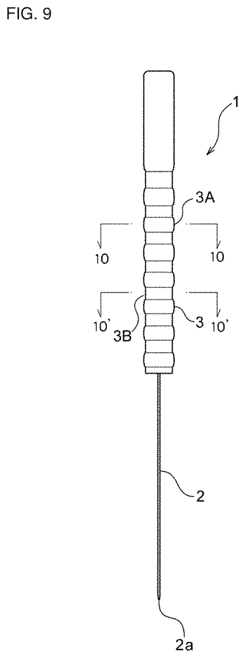

In addition, FIGS. 11-14 show that each of the acupuncture needles 1 in FIGS. 1, 7, and 9 is also applicable to “a needle tube 9, in which the acupuncture needle 1 is inserted at a time of piercing a skin, to assist piercing the skin.”

That is, a needle tube 9 is included, in which the acupuncture needle 1 is inserted at the time of piercing the skin, to assist the piercing, and the needle tube 9 allows the acupuncture needle 1 to move in the longitudinal direction. Among the straight lines crossing the outer peripheral edge of the cross section crossing the longitudinal direction of the needle grip 3, the first long side having the length longest between one portion of the outer peripheral edge and another portion of the outer peripheral edge, and among the straight lines orthogonal to this first long side and crossing the outer peripheral edge of the cross section, a second long side having the length longest between one portion of the outer peripheral edge and another portion of the outer peripheral edge are in a relation satisfying the length of the first long side>the length of the second long side.

Specifically, the cross-sectional shape of the needle grip 3 crossing the longitudinal direction is an ellipse, a polygon, or a polygon with chamfered corners.

In the case that the cross-sectional shape is the ellipse, the needle tube 9 has an outer shape of the cross section crossing the longitudinal direction of the needle tube 9 being an ellipse, and a gap t between the needle tube 9 and the needle grip 3 to allow the acupuncture needle 1 to move in the longitudinal direction. That is, the needle tube 9 has an inner wall shape of the cross section crossing the longitudinal direction of the needle tube 9 and the outer wall shape being an ellipse having a constant plate thickness ensured from the inner wall shape, and the inner wall shape of the needle tube 9 has the gap t allowing the acupuncture needle 1 to move in the longitudinal direction.

In the case that the cross-sectional shape is the polygon or the polygon with chamfered corners, the needle tube 9 has an outer shape of the cross section crossing the longitudinal direction of the needle tube 9 being a polygon or a polygon with chamfered corners, and a gap t between the needle tube 9 and the needle grip 3 to allow the acupuncture needle 1 to move in the longitudinal direction. That is, the needle tube 9 has an inner wall shape of the cross section crossing the longitudinal direction of the needle tube 9 and the outer wall shape being a polygon or polygon with chamfered corners having a constant plate thickness ensured from the inner wall shape, and the inner wall shape of the needle tube 9 has the gap t allowing the acupuncture needle 1 to move in the longitudinal direction.

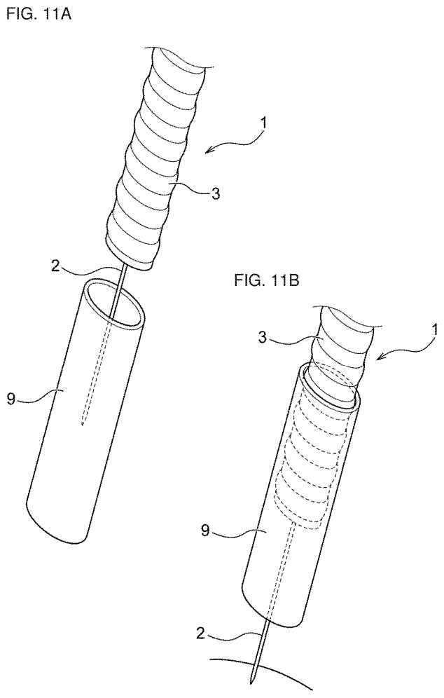

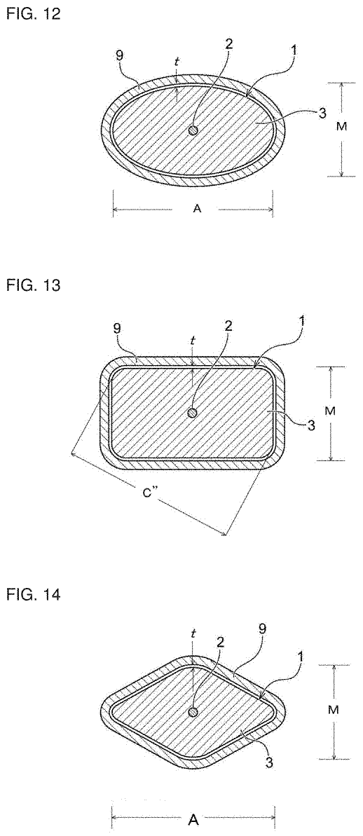

More specifically, in the case that the cross-sectional shape of the needle grip 3 crossing the longitudinal direction is an ellipse, as shown in FIG. 12, the cross-sectional shape of the needle tube 9 crossing the longitudinal direction is an ellipse. In the case that the cross-sectional shape of the needle grip 3 crossing the longitudinal direction is a polygon, e.g., a rectangle, or a polygon with chamfered corners, e.g., a rectangle with chamfered corners, as shown in FIG. 13, the cross-sectional shape of the needle tube 9 crossing the longitudinal direction is a rectangle. In the case that the cross-sectional shape of the needle grip 3 crossing the longitudinal direction is a polygon, e.g., a rhombus or a polygon with chamfered corners, e.g., a rhombus with chamfered corners, as shown in FIG. 14, the cross-sectional shape of the needle tube 9 crossing the longitudinal direction is a rhombus.

As shown in FIGS. 12, 13, and 14, in the cross section of the needle grip 3 inside the needle tube 9 crossing the longitudinal direction of the needle tube 9, the inner wall of the needle tube 9 is provided along the outer surface of the needle grip 3 with a space t therebetween the outer surface of the needle grip 3, and allows the acupuncture needle 1 in the needle tube 9 to move in the longitudinal direction. The outer wall of the needle tube 9 is provided along the inner wall of the needle tube 9. That is, the outer wall shape of the needle tube 9 is the shape of the inner wall with a constant plate thickness secured.

Among the opposing distances of the needle tube 9, the shortest length is the first opposing distance M shown in FIGS. 12, 13, and 14.

In FIG. 12, among the straight lines crossing the outer peripheral edge of the cross section crossing the longitudinal direction of the needle grip 3, the length of the first long side having the longest length between one portion of the outer peripheral edge and another portion of the outer peripheral edge is the length A of the major axis wherein a relation of the first long side A>the first opposing distance M is satisfied.

In FIG. 13, among the straight lines crossing the outer peripheral edge of the cross section crossing the longitudinal direction of the needle grip 3, the length of the first long side having the longest length between one portion of the outer peripheral edge and another portion of the outer peripheral edge is the length C″ of the diagonal line wherein a relation of the length C″ of the first long side>the first opposing distance M is satisfied.

In FIG. 14, among the straight lines crossing the outer peripheral edge of the cross section crossing the longitudinal direction of the needle grip 3, the length of the first long side having the longest length between one portion of the outer peripheral edge and another portion of the outer peripheral edge is the length A wherein the length A of the first long side>the first opposing distance M is satisfied.

That is, in a cross section of the needle grip 3 in the needle tube 9 crossing the longitudinal direction of the needle tube 9, the outer wall of the needle tube 9 and the outer surface of the needle grip 3 are similar to each other and the position of the needle tube 9 and the position of the needle grip 3 are proximate to each other so that when the needle tube 9 is used to insert the acupuncture needle 1 in a concentrated arrangement as shown in FIG. 6, the needle grip 3 is positioned at a predetermined position of the needle tube 9.

The needle tube 9 can be set to a dimension that allows the needle grip 3 to move in the longitudinal direction, to assist piercing the skin by the acupuncture needle 1.

Further, the needle tube 9 is used to reduce pain by making the needle body 2 difficult to bend when the needle body 2 of the acupuncture needle 1 is inserted into the body, and the dimension of the needle tube 9 in the longitudinal direction is set several millimeters shorter than the length of the acupuncture needle 1.

What is claimed is:

1. An acupuncture needle, comprising:
a needle body having a needle tip portion at a leading end thereof; and
a needle grip attached to a base end portion of the needle body, wherein
a cross-sectional shape of the needle grip crossing a longitudinal direction is an ellipse,
the needle tip portion has a pointed-shape and not a hook-shape,
the needle body is in a linear shape without being curved in a middle thereof, and
the needle body is not removable from the needle grip.

2. An acupuncture needle, comprising:
a needle body having a needle tip portion at a leading end thereof; and
a needle grip attached to a base end portion of the needle body, wherein
a cross-sectional shape of the needle grip crossing a longitudinal direction is an ellipse,
a surface of the needle grip has a concave-convex portion along the longitudinal direction of the needle grip,
a major axis of a cross-sectional shape of a concave portion of the concave-convex portion crossing the longitudinal direction of the needle grip being the ellipse is smaller than a major axis of the cross-sectional shape of a convex portion of the concave-convex portion crossing the longitudinal direction of the needle grip being the ellipse,
a minor axis of the cross-sectional shape of the concave portion crossing the longitudinal direction of the needle grip being the ellipse is smaller than a minor axis of the cross-sectional shape of the convex portion crossing the longitudinal direction of the needle grip being the ellipse,
the needle tip portion has a pointed-shape and not a hook-shape,
the needle body is in a linear shape without being curved in a middle thereof, and
the needle body is not removable from the needle grip.

3. The acupuncture needle according to claim 1, further comprising:
a needle tube configured to receive the acupuncture needle at a time of piercing a skin to assist piercing the skin, wherein
an outer shape of a cross section of the needle tube crossing the longitudinal direction is an ellipse,
among opposing distances of the needle tube, a first opposing distance has a shortest length,
a cross-sectional shape of the needle tube crossing the longitudinal direction is an ellipse, and
a relation of a length of a major axis of the ellipse>the first opposing distance is satisfied.

4. An acupuncture needle, comprising:
a needle body having a needle tip portion at a leading end thereof; and
a needle grip attached to a base end portion of the needle body, wherein
a surface of the needle grip has a concave-convex portion along a longitudinal direction of the needle grip,
among straight lines crossing an outer peripheral edge of a cross section crossing the longitudinal direction of the needle grip at a convex portion of the concave-convex portion, a first long side having a length longest between one portion of an outer peripheral edge and another portion of the outer peripheral edge, and among straight lines orthogonal to the first long side and crossing the outer peripheral edge of the cross section, a second long side having a length longest between one portion of the outer peripheral edge and another portion of the outer peripheral edge are in a relation such that the length of the first long side>the length of the second long side is satisfied; and
among straight lines crossing the outer peripheral edge of the cross section crossing the longitudinal direction of the needle grip at a concave portion of the concave-convex portion, another first long side having a length longest between one portion of the outer peripheral edge and another portion of the outer peripheral edge, and among straight lines orthogonal to the another first long side and crossing the outer peripheral edge of the cross section, another second long side having a length longest between one portion of the outer peripheral edge and another portion of the outer peripheral edge are in a relation such that the length of the another first long side>the length of the another second long side is satisfied.

5. The acupuncture needle according to claim 4, further comprising:
a needle tube configured to receive the acupuncture needle at a time of piercing a skin to assist piercing the skin, wherein
an inner wall of the needle tube is provided along an outer surface of the needle grip with a space therebetween the outer surface of the needle grip to allow the acupuncture needle in the needle tube to move in the longitudinal direction,
an outer wall of the needle tube is along the inner wall of the needle tube,
among opposing distances of the needle tube, a shortest length is a first opposing distance, and
a relation of the length of the first long side>the first opposing distance is satisfied.
